(19) United States
(12) Patent Application Publication
(10) Pub. No.: US 2019/0336991 A1
(43) Pub. Date: Nov. 7, 2019

(54) SPRINKLER HEAD

(71) Applicants: DON DUFFIN, PAUL, ID (US); ROGER DUFFIN, PAUL, ID (US)

(72) Inventors: DON DUFFIN, PAUL, ID (US); ROGER DUFFIN, PAUL, ID (US)

(21) Appl. No.: 16/182,480

(22) Filed: Nov. 6, 2018

Related U.S. Application Data
(60) Provisional application No. 62/581,904, filed on Nov. 6, 2017.

(51) Int. Cl. B05B 3/00

(52) U.S. Cl. CPC B05B 3/008

(57) ABSTRACT

What is disclosed is an improved sprinkler utilizing a nutation mechanism. The sprinkler utilizes a race having an upper limit and lower limit. The tire is connected to the distributor. Water sprays on the distributor causing the nutation of the device in which the tire moves between the upper race and lower race limits. The sprinkler includes a separate starting mechanism on which a starting bump is positioned on a distributor support.

### TECHNICAL FIELD

The herein disclosed and claimed inventive concepts generally relates to a sprinkler head, and more particularly to a nutation sprinkler head for randomizing liquid distribution.

### BRIEF DESCRIPTION OF THE DRAWINGS

FIG. 1 is an illustration of a front cutaway view of a first embodiment of a sprinkler head.

FIG. 2 is an illustration of a front exploded view of a first embodiment of a sprinkler head.

FIG. 3 is a front view of a first embodiment of a sprinkler head.

FIG. 4 is an isometric view of a first embodiment of a sprinkler head.

FIG. 5 is a front cutaway view of a second embodiment of a sprinkler head.

FIG. 6 is a front exploded view of a second embodiment of a sprinkler head.

FIG. 7 is a front view of a second embodiment of a sprinkler head.

FIG. 8 is an isometric view of a second embodiment of a sprinkler head.

### SUMMARY OF INVENTION

The purpose of the Summary of Disclosure is to enable the public, and especially the scientists, engineers, and practitioners in the art who are not familiar with patent or legal terms or phraseology, to determine quickly from a cursory inspection, the nature and essence of the technical disclosure of the application. The Summary of the Invention is neither intended to define the invention of the application, which is measured by the claims, nor is it intended to be limiting as to the scope of the invention in any way.

A liquid, preferably water, distributing sprinkler head that has a housing with an attached nozzle. The nozzle is connected to an adapter that will be attached to an incoming liquid supply. The sprinkler comprises a tire carrier assembly comprising of a tire and a lower tire.

The sprinkler comprises a distributor with the distributor hanging loosely from an arm holder. The distributor has a lower plate that is held in a spaced apart relationship by one or more arms connected to a swashing ring. The lower plate has a lower plate first side having a generally peaked surface profile with an upturned edge at the periphery of the plate. The peaked surface incised by spirally radiating grooves with a peak on the lower plate first side centrally positioned and having a beveled top surface.

The distributor is configured to hang freely from the swashing ring when distributor is idle with the bevel on the lower plate configured to be deflected by an initial jet of liquid from an incoming liquid supply that travels through the sprinkler. The distributor begins a nutation motion after the initial deflection with the nutation motion maintained by the force of liquid on the spirally radiating grooves.

The arm holder comprises a starting bump, wherein the swashing ring rests on the starting bump when sprinkler is idle causing the distributor to tilt allowing for initialization of nutation motion.

The tire and lower tire of the sprinkler encapsulate the swashing ring which provides sufficient friction between the swashing ring and the tire and prevents slipping.

The sprinkler further comprises additional weight in said sprinkler body. Still other features and advantages of the claimed invention will become readily apparent to those skilled in this art from the preceding detailed description of preferred embodiments of the invention, simply by way of illustration of the best mode contemplated by carrying out my invention. As will be realized, the invention is capable of modification in various obvious respects all without departing from the invention. Accordingly, the description of the preferred embodiments are to be regarded as illustrative in nature, and not as restrictive in nature.

### DETAILED DESCRIPTION OF THE EXEMPLARY EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

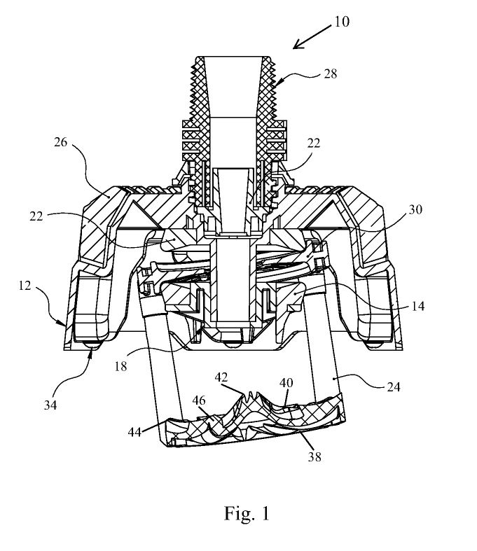

Certain preferred embodiments of the disclosed technology are shown in FIGS. 1 through 8.

FIG. 1 is a front view of the cutaway section of the liquid sprinkler 10. In a preferred embodiment the liquid sprinkler 10 is connected to a pipe or another fluid delivery mechanism. Shown is the housing 12 which encapsulates the inner workings of the liquid sprinkler 10. The swashing ring 30 spoils the liquid in a spinning motion that wobbles and nutates as the liquid hits the distributor 24. The swashing ring 30 helps the initial facilitation of the nutation process. The swashing ring 30 is connected to the top of the distributor 24.

In a preferred embodiment, the distributor 24 has arms that extend down from the housing 12. When liquid leaves the nozzle 22, it strikes the distributor 24 which causes liquid to be distributed in a spoiling motion. In other embodiments, the sprinkler can have a lower tire 16 as well an original tire. The tire 14 comprises of a polyurethane material; however, the tire 14 and the lower tire 16 can be different types of elastomers. The tire 14 has rigid structure inside of the elastomeric which makes it compact.

In a preferred embodiment, the motion of the distributor 24 is nutation which is a combination of spinning and rolling.

In a preferred embodiment, the sprinkler 10 has a nozzle 22 which delivers the liquid through the sprinkler 10. Liquid is delivered to the nozzle 22 from the adapter 28 which is connected to a pipe or hose that provides an incoming source of liquid.

In a preferred embodiment, the tire carrier assembly 18 is in place to hold the lower tire 16. Shown is a coupling element 34 which secures the housing 12. Secured to the housing 12, is the weight 26. In a preferred embodiment, the material of the weight 26 is zinc, however, it a can be any number of materials in other embodiments. The weight 26 allows the sprinkler 10 to hang from a hose in a stabilized manner, protecting the sprinkler 10 from manipulation by wind.

In a preferred embodiment, the arm holder 20 holds the tire carrier assembly 18 centered when not in operation. The arm holder 20 comprises of a starting bump 36. When the sprinkler 10 is not in use, the distributor 24 hangs loosely from the arm holder 20. The starting bump 36 allows for the initiation of the nutation process by forcing a tilted position of the distributor 24 so when liquid initially strikes the distributor 24 it will begin the nutation process. The starting bump 36 rest on a flanged end of the arm holder 20. When the distributor 24 hangs loosely from the arm holder 20, it teeters on the starting bump 36 causing the distributor 24 to be unstable when liquid strikes, initiating the nutation of the sprinkler.

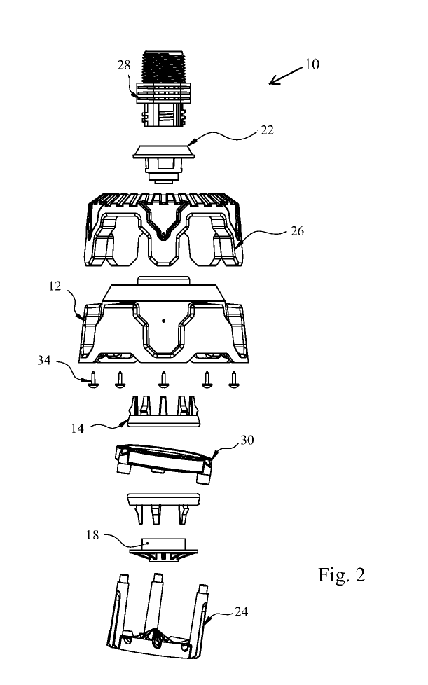

FIG. 2 is a front exploded view of the sprinkler head 10. In a preferred embodiment, the adapter 28 connects to the nozzle 22. The weight 26 is secured to the housing 12 and coupled together using the coupling element 34. The tire 14 is adjacent to the swashing ring 30. Also shown is the tire carrier assembly 18 and the distributor 24.

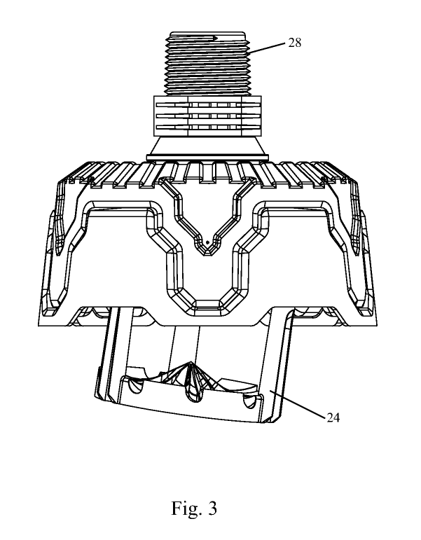

FIG. 3 is a front view of the assembled sprinkler head 10. In a preferred embodiment, the distributor 24 hangs from the housing. The distributor 10 comprises of a peaked surface that distributes liquid evenly as it strikes the distributor 10. The adapter 28 connects the sprinkler 10 to an external liquid source.

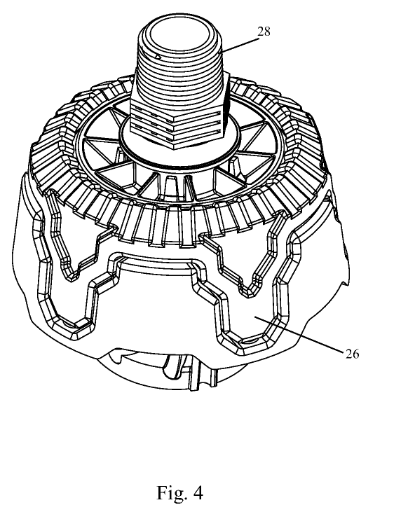

FIG. 4 is an isometric view of an alternate embodiment of a sprinkler head 10. The illustration depicts a sprinkler head having an adapter 28 for connection to an irrigation system. The adapter attaches to a weight plate that attaches to a housing 26. In a preferred embodiment, the weight 26 stabilizes the sprinkler when it is in operation as well as protects the sprinkler from external elements.

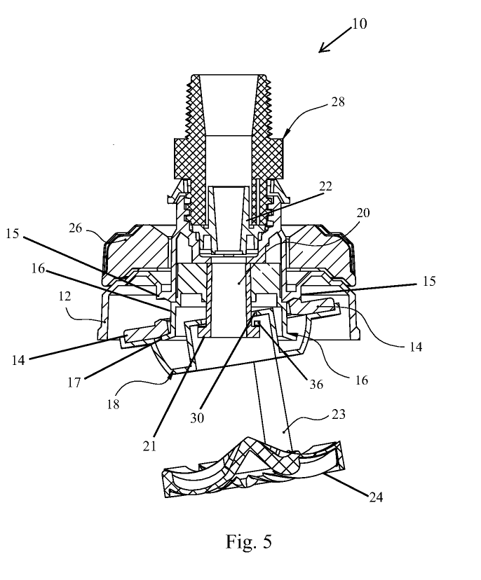

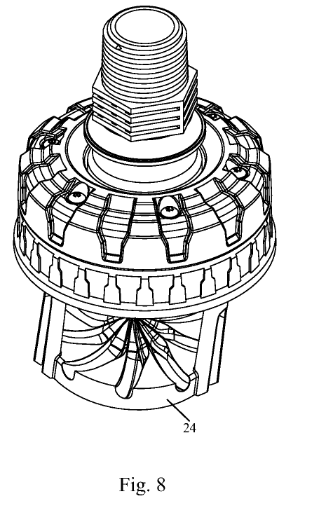

FIG. 5 is a front cutaway view of the sprinkler head 10 with arm holder 20. The sprinkler can be constructed with one arm 24 or multiple arms as depicted in FIG. 8. In a preferred embodiment, the liquid flows through an adapter 28, a nozzle 22, and through the arm holder 20 to the distributor 24. The sprinkler 10 utilizes a weight 26, fastened to a housing 12 to provide weight to stabilized the sprinkler and to protect the sprinkler. When the sprinkler is not in operation, the distributor hangs from the arm holder 20 at an off center position due to starting bump 36 positioned on the ledge of the arm holder 20. There can be one or more starting bumps. In operation, the tire 14 moves nutates in response liquid being sprayed on the distributor. The nutation moves the tire 14 between the upper limit 15 of the race 16 and the lower limit of the race 17. The tire 14 is attached to a tire carrier assembly 18 which includes a upper projection 30 that rests on the one or more starting bump when the sprinkler is not in operation. When in operation the upper projection of the tire carrier assembly does not contact the starting bumps due to the nutation action of the tire within the race. In a preferred embodiment the race is constructed of a rigid material whereas the tire is a material of a less rigid nature, such as a rubber material.

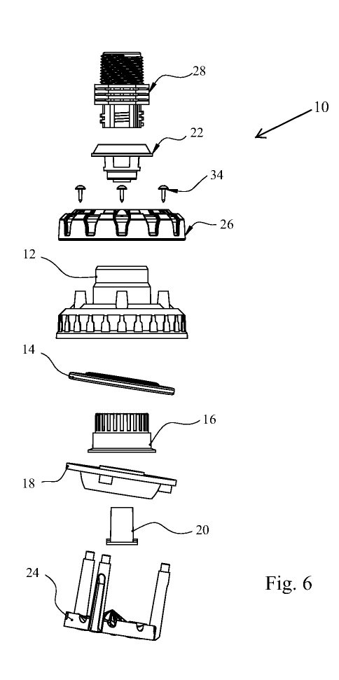

FIG. 6 is a sprinkler head 10 with arm holder 20 front exploded view. In a preferred embodiment, the sprinkler 10 comprises an adapter 28 joined to a nozzle 22. The nozzle sits in the housing 12 which is coupled to a weight 26 using a coupling element 34. The distributor 24 hangs from an arm holder 20. The tire 14 is joined to the tire carrier assembly 18.

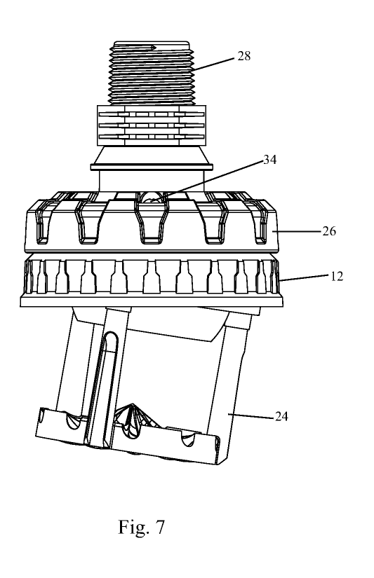

FIG. 7 is a front view of the sprinkler head 10 with arm holder 20. In a preferred embodiment, the adapter 28 connects the sprinkler to an external liquid source. The weight 26 is coupled to the housing 12 using the coupling element 34. The distributor 24 hangs loosely from the arm holder 20 when the sprinkler is not in use.

FIG. 8 is a sprinkler head 10 with arm holder 20 Isometric view. In a preferred embodiment, the adapter 28 connects the sprinkler to an external liquid source. The weight 26 is coupled to the housing 12 using the coupling element 34.

We claim:

1. A liquid distributing sprinkler head, comprising,
a housing, with an attached nozzle, said nozzle connected to an adapter to be attached to an incoming liquid supply;
a tire carrier assembly comprising of a tire and a lower tire;
a distributor with said distributor hanging loosely from an arm holder, said distributor with a lower plate, said lower plate held in a spaced apart relationship by one or more arms connected to a swashing ring;
said lower plate having a lower plate first side having a generally peaked surface profile with an upturned edge at the periphery of the plate, said surface incised by spirally radiating grooves with a peak on said lower plate first side centrally positioned and having a beveled top surface; wherein
said distributor is configured to hang freely from said swashing ring when distributor is idle, with said bevel on said lower plate configured to be deflected by an initial jet of liquid from an incoming liquid supply that travels through said sprinkler, and for the distributor to begin a nutation motion after said initial deflection with said nutation motion maintained by the force of liquid on said spirally radiating grooves; and
said arm holder comprises a starting bump, wherein said swashing ring rests on said starting bump when sprinkler is idle causing said distributor to tilt allowing for initialization of nutation motion.

2. The sprinkler of claim 1 which further comprises said tire and said lower tire encapsulate said swashing ring providing sufficient friction between said swashing ring and said tire and to prevent slipping.

3. The sprinkler head of claim 1 which further comprises additional weight in said sprinkler body.

4. A liquid distributing sprinkler head, comprising,
a housing, with an attached nozzle, said nozzle connected to an adapter to be attached to an incoming liquid supply;
a tire carrier assembly comprising of a tire and a lower tire;
a distributor with said distributor hanging loosely from an arm holder, said distributor with a lower plate, said lower plate held in a spaced apart relationship by one or more arms connected to a swashing ring;
said lower plate having a lower plate first side having a generally peaked surface profile with an upturned edge at the periphery of the plate, said surface incised by spirally radiating grooves with a peak on said lower plate first side centrally positioned and having a beveled top surface; wherein
said distributor is configured to hang freely from said swashing ring when distributor is idle, with said bevel on said lower plate configured to be deflected by an initial jet of liquid from an incoming liquid supply that travels through said sprinkler, and for the distributor to begin a nutation motion after said initial deflection with said nutation motion maintained by the force of liquid on said spirally radiating grooves; and
said swashing ring comprises a starting bump, wherein said swashing ring rests on said starting bump when sprinkler is idle causing said distributor to tilt allowing for initialization of nutation motion.
